(19) United States
(12) Patent Application Publication
(10) Pub. No.: US 2020/0406956 A1
(43) Pub. Date: Dec. 31, 2020

(54) STEERING SYSTEM SHAFT BEARING ASSEMBLY, STEERING SYSTEM AND METHOD FOR PRODUCING A STEERING SYSTEM

(71) Applicant: ZF Automotive Germany GmbH, Alfdorf (DE)

(72) Inventor: Gregor Watzlawek, Düsseldorf (DE)

(73) Assignee: ZF Automotive Germany GmbH, Alfdorf (DE)

(21) Appl. No.: 16/976,164

(22) PCT Filed: Feb. 5, 2019
(86) PCT No.: PCT/EP2019/052699

§ 371 Date: Aug. 27, 2020

(30) Foreign Application Priority Data
Feb. 28, 2018 (DE) 10 2018 104 608.1

(51) Int. Cl. B62D 5/04; F16C 35/067

(52) U.S. Cl. CPC B62D 5/0403; F16C 2226/60; F16C 2326/24; F16C 35/067

(57) ABSTRACT

A steering system shaft bearing assembly having a shaft includes a rotatably mounted about a shaft axis in a housing made of plastic via a rolling bearing. In this case, the rolling bearing is fastened to the housing by means of a fastening ring which cooperates with an internal thread on the housing side and has an external thread. The present disclosure further relates to a steering system for a motor vehicle, comprising such a steering system shaft bearing assembly. Furthermore, a method for producing such a steering system is disclosed.

### CROSS-REFERENCE TO RELATED APPLICATION

This application is a national stage of International Application No. PCT/EP19/052699, filed Feb. 5, 2019, the disclosure of which is incorporated herein by reference in its entirety, and which claimed priority to German Patent Application No. 102018104608.1, filed Feb. 28, 2018, the disclosure of which is incorporated herein by reference in its entirety.

### TECHNICAL FIELD

The present disclosure relates to a steering system shaft bearing assembly and to a steering system for a motor vehicle, in particular an automobile, with a steering system shaft bearing assembly. In addition, the present disclosure relates to a method for producing a steering system of this type.

### BACKGROUND

Steering systems for motor vehicles are known from the prior art. Since steering systems as a rule comprise a plurality of shafts, steering system shaft bearing assemblies are also known, via which the various shafts are mounted within the steering system.

The shafts can be a steering system input shaft which is operatively connected to a steering wheel, a steering system output shaft, by means of which a track rod of the steering system can be actuated, for example, with utilization of a power steering drive, and/or a shaft of a gear unit of the steering system. Here, the abovementioned shafts are usually mounted in housings. In the field of steering systems overall, the aim is always for them to be constructed as simply as possible and produced as inexpensively as possible.

### SUMMARY

Against this background, it is the object of the present present disclosure to specify an improved steering system and an improved steering system shaft bearing assembly.

The object is achieved by way of a steering system shaft bearing assembly of the type mentioned at the outset, which comprises a shaft which is mounted in a housing made from plastic via an anti-friction bearing such that it can be rotated about a shaft axis, the anti-friction bearing being fastened to the housing by means of a fastening ring which has an external thread and cooperates with a housing-side internal thread. Here, the external thread of the fastening ring engages into the housing-side internal thread. In this context, the term “shaft” is additionally to be understood broadly. Instead of a shaft, an axle can also be mounted in the housing. Here, the anti-friction bearing is preferably configured as a locating bearing. It is irrelevant for the present present disclosure how the anti-friction bearing is connected to the shaft. By way of example, the anti-friction bearing, or more precisely its inner ring, can be seated on a shaft shoulder and can bear axially against a shaft-side bearing face. On that side of the inner ring which is opposed with respect to the shaft side bearing face, said inner ring can be held on the shaft via a securing ring. Here, in particular, what is known as a tapered ring can be used as a securing ring, by way of which tapered ring the inner ring is held under stress on the shaft-side bearing face. By virtue of the fact that the housing is made from plastic, it can be produced simply and inexpensively. In addition, it is of light weight. This applies, in particular, in comparison with known housings made from metal. This therefore also results in a steering system shaft bearing assembly which can be produced simply and inexpensively.

As a result of the housing-side internal thread and the fastening ring, known devices for fastening the anti-friction bearing can be dispensed with. This applies, in particular, to devices of the type which make machining of the housing necessary, for example a securing ring which is arranged in an associated groove, in particular a tapered ring. The housing preferably has no undercuts in the axial direction apart from the internal thread. In addition, it can advantageously be produced without a metal cutting step. As a consequence, it can be produced particularly simply.

The fastening ring preferably has an axial thickness of from 5 mm to 30 mm, in particular of from 5 mm to 20 mm. In one exemplary embodiment, the fastening ring is 10 mm thick.

The fastening ring is preferably produced from metal, in particular from an aluminum material, or from plastic.

The plastic can be fiber reinforced plastic. A plastic of this type has particularly satisfactory mechanical properties, in particular a particularly high strength and rigidity. For the case where what are known as short fibers are used to reinforce the plastic, the housing can additionally be produced by means of polymer engineering production methods. Production methods of this type are particularly efficient, in particular in the case of large quantities.

In accordance with one embodiment, an outer ring of the anti-friction bearing is mounted on a housing shoulder of the housing radially with regard to the shaft axis, and/or bears against a housing-side stop face axially with regard to the shaft axis. The outer ring is therefore held simply and reliably on the housing.

Here, the internal thread can be arranged adjacently with respect to the housing shoulder along the shaft axis, the internal thread adjoining the housing shoulder, in particular. The stop face and the internal thread are therefore provided on opposite sides of the housing shoulder. Here, an internal diameter of the internal thread is preferably at least identical to, and preferably greater than, a diameter of the housing shoulder. It therefore becomes possible to push the anti-friction bearing through the internal thread onto the housing shoulder. This thus results overall in a particularly compact construction of the steering system shaft bearing assembly.

On an axial side which is opposed with respect to the housing-side stop face, the outer ring advantageously bears against a stop face on the fastening ring side. The outer ring of the anti-friction bearing is therefore held axially on both sides; “axially” is always to be understood in relation to the shaft axis. The outer ring is therefore positioned reliably and precisely, which results overall in reliable mounting of the shaft.

The anti-friction bearing is preferably mounted substantially without play on the housing. Undesired noise which can be produced in the case of mounting with play is therefore avoided reliably. This additionally results in precise and durable mounting. The anti-friction bearing, in particular its outer ring, can also be held under prestress on the housing. This ensures, for example, that the outer ring is held precisely even under the influence of temperature-induced longitudinal expansions and vibrations. Here, the prestress can be set in an infinitely variable manner via the external thread which is provided on the fastening ring, in conjunction with the housing-side internal thread.

In one variant, the shaft extends through the fastening ring. Here, the preferred construction of the steering system shaft bearing assembly is as follows, as viewed from a housing interior to a housing exterior: housing-side stop face, housing shoulder, internal thread with fastening ring. The fastening ring can therefore lie in the region of a housing wall. The steering system shaft bearing assembly according to the present disclosure can therefore also be used at bearing points, at which the shaft projects out of the housing. In addition, the bearing point is thus readily accessible via the fastening ring, which entails comparatively simple maintenance.

The fastening ring can comprise at least one tool engagement contour which is configured to interact with a tool, by means of which the fastening ring can be screwed. The fastening ring can therefore be screwed into the housing and out of the housing with the aid of the tool. Simple mounting and dismantling of the fastening ring are therefore ensured.

The housing is preferably a sensor housing or a gear housing of a steering system for a motor vehicle, in particular for an automobile. In this context, a sensor housing is a housing, in the interior of which a sensor is arranged. The sensor is preferably a rotary angle sensor or a torque sensor. A gear housing is to be understood here to mean a housing, in which a gear mechanism is arranged. This gear mechanism is preferably a worm gear, with the result that the gear housing can also be called a worm gear housing.

Here, the housing can be an injection molded housing, and the internal thread can be produced during the injection molding. The injection molding method is an efficient production method, in particular for large quantities. The housing can therefore be produced simply and inexpensively. In addition, a housing of this type is of particularly light weight in comparison with known housings made from metal.

During the injection molding, the internal thread is produced by virtue of the fact that a core is used which is equipped with an external thread and is overmolded with liquid plastic. After the solidification of the plastic, the core can be screwed out of the housing.

The object is additionally achieved by way of a steering system of the type mentioned at the outset, with a steering system shaft bearing assembly according to the present disclosure. Since the steering system shaft bearing assembly can be produced simply and inexpensively, this also applies to the steering system overall. The same applies to the weight. The steering system is therefore comparatively light.

a) Furthermore, the object is achieved by way of a method of the type mentioned at the outset for producing a steering system,

b) in order to form a housing, a core which has an external thread being surrounded by way of flowable plastic, the core being overmolded with flowable plastic in an injection molding method, in particular,

c) the core being subsequently screwed out of the housing using the external thread, and leaving an internal thread in the housing, and

d) an anti-friction bearing being inserted into the housing.

In particular, the core is overmolded only on its shell, that is to say is overmolded only radially. In this way, the core can also be removed from the housing again easily.

Although, strictly speaking, the internal thread here represents an undercut with regard to the axial direction, said undercut requires neither remachining of the housing nor destruction of the core. As a result, the method becomes particularly inexpensive.

Here, in order to fasten the anti-friction bearing, a fastening ring which has an external thread can be screwed into the internal thread.

### BRIEF DESCRIPTION OF THE DRAWINGS

The present disclosure will be described in the following text on the basis of various exemplary embodiments which are shown in the appended drawings, in which:

FIG. 1 shows a section of a steering system according to the present disclosure with a steering system shaft bearing assembly according to the present disclosure, the steering system being produced by means of the method according to the present disclosure,

FIG. 2 shows a longitudinal section through that section of the steering system which is shown in FIG. 1,

FIG. 3a shows what is known as a sensor housing of the steering system from FIG. 1 in a first perspective view,

FIG. 3b shows what is known as a sensor housing of the steering system from FIG. 1 in a second perspective view,

FIG. 3c shows what is known as a sensor housing of the steering system from FIG. 1 in a third perspective view,

FIG. 4 shows a detail of that region from FIG. 2 which is described using IV,

FIG. 5 shows a fastening ring of the steering system from FIG. 1 in a perspective illustration,

FIG. 6 shows a further section of a steering system according to the present disclosure with two steering system shaft bearing assemblies according to the present disclosure in accordance with further embodiments, the steering system being produced by means of the method according to the present disclosure,

FIG. 7 shows a gear unit of the steering system from FIG. 6, which gear unit comprises two steering system shaft bearing assemblies according to the present disclosure,

FIG. 8 shows a sectional illustration of a first steering system shaft bearing assembly from FIG. 7,

FIG. 9 shows a sectional illustration of a second steering system shaft bearing assembly from FIG. 7, and

FIG. 10 shows an illustration of a detail of the method according to the present disclosure.

### DETAILED DESCRIPTION

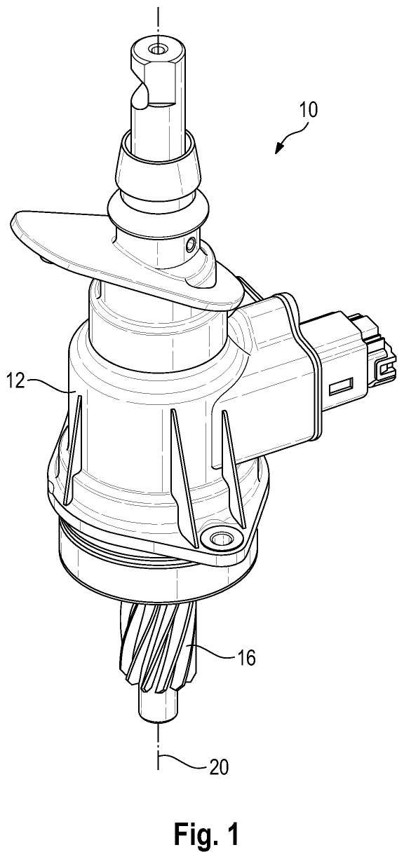

FIG. 1 shows a detail of a steering system 10 for an automobile. The steering system 10 comprises a housing 12 which is configured as what is known as a sensor housing in the embodiment which is shown. In this context, a torque sensor 14 is arranged within the housing 12.

In addition, a shaft 16, which is a steering system output shaft in the present case, is mounted in the housing 12 by means of a steering system shaft bearing assembly 18. Here, the shaft 16 can be rotated about a shaft axis 20.

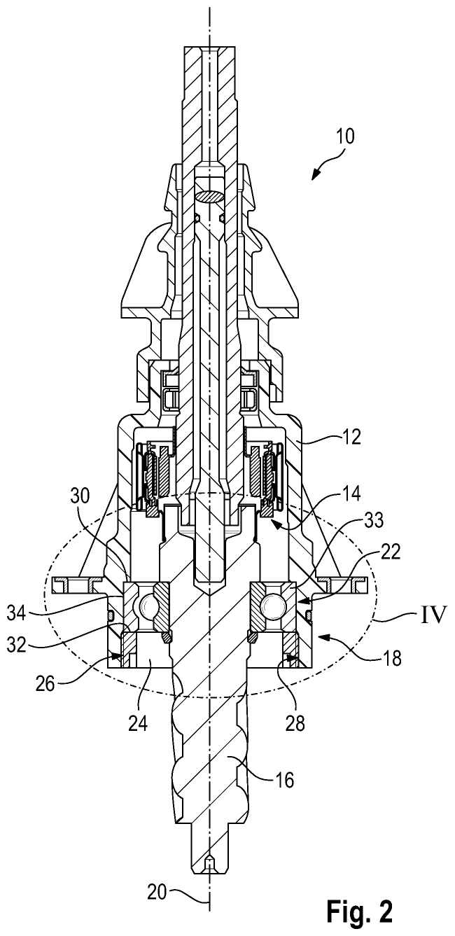

For this purpose, the shaft 16 is mounted in the housing 12 via an anti-friction bearing 22, the anti-friction bearing 22 being fastened to the housing 12 by means of a fastening ring 24 which has an external thread 26. For this purpose, the external thread 26 cooperates with a housing-side internal thread 28 (see FIGS. 2 and 4). The anti-friction bearing 22 bears against a housing-side stop face 30 axially with regard to the shaft axis 20. On a side which is opposed with respect to the housing-side stop face 30, the anti-friction bearing 22 bears against a stop face 32 on the fastening ring side. In the radial direction, an outer ring 33 of the anti-friction bearing 22 is mounted on a housing shoulder 34.

As viewed along the shaft axis 20, the internal thread 28 is therefore arranged adjacently with respect to the housing shoulder 34. In the embodiment which is shown, furthermore, it adjoins an end of the housing shoulder 34, which end is opposed with respect to the housing-side stop face 30. Overall, the anti-friction bearing 22 is mounted on the housing 12 substantially without play. As can be seen, moreover, on the basis of the exemplary embodiment which is shown, the shaft 16 extends through the fastening ring 24 and protrudes out of the housing 12.

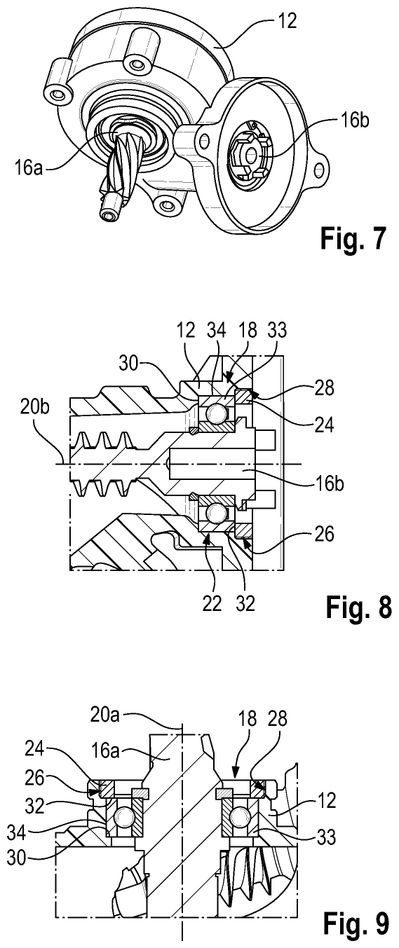

FIGS. 6 to 9 show alternative embodiments of the steering system shaft bearing assembly 18. In said embodiments, the housing 12 is a gear housing, more precisely a worm gear housing. It is arranged in another section of the steering system 10 in comparison with the sensor housing (see FIG. 6). Here, the worm gear which is arranged in the housing 12 comprises a first shaft 16a which is, for example, a worm gear shaft, and a second shaft 16b which is, for example, a worm shaft.

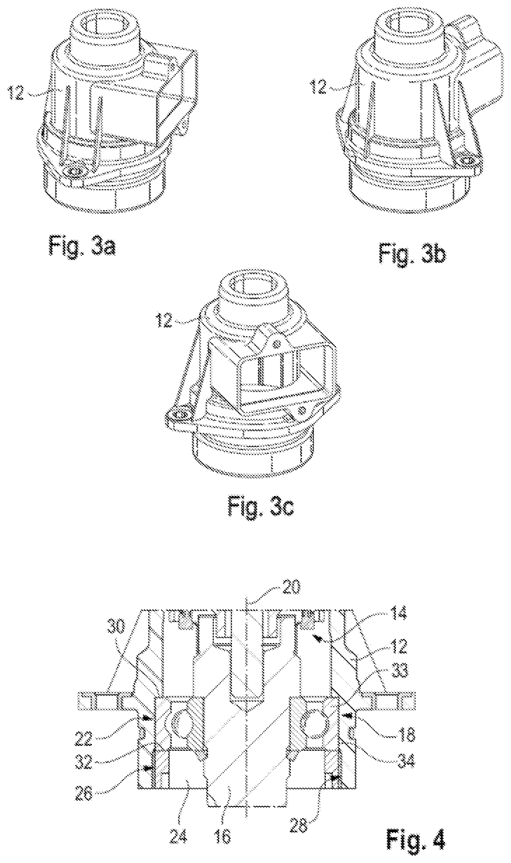

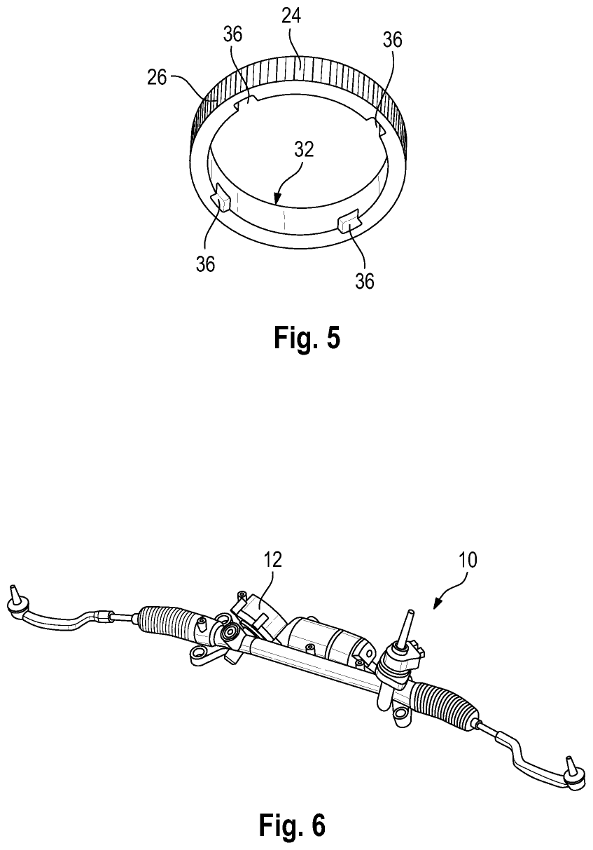

Both the first shaft 16a and the second shaft 16b are mounted in the housing 12 by means of a steering system shaft bearing assembly 18 according to the present disclosure. Since the steering system shaft bearing assemblies 18 according to FIGS. 6 to 9 do not differ from the steering system shaft bearing assembly 18 which is described on the basis of FIGS. 1 to 5, reference is made to the above comments. In all of the embodiments which are shown, the housing 12 is made from plastic. In addition, the housing 12 is an injection molded housing, in the case of which the internal thread 28 is produced during the injection molding.

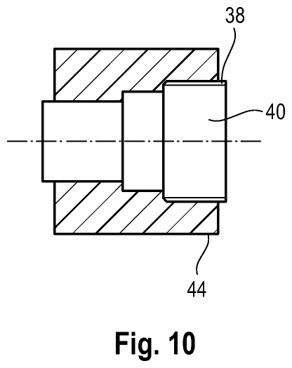

This takes place as follows: first of all, a core 40 which has an external thread 38 (see FIG. 10) is surrounded with flowable plastic 42 within the context of an injection molding method. The core 40 is therefore encapsulated with flowable plastic 42. Here, an outer contour of the housing 12 is determined by way of an injection mold 44, into which the core 40 is inserted. FIG. 10 shows the injection mold 44 in a merely roughly diagrammatic manner. After the plastic 42 has hardened, the core 40 is screwed out of the housing 12 using the external thread 38, and thus leaves behind the internal thread 28 in the housing 12. Afterward, the anti-friction bearing can be inserted into the housing 12. The fastening ring 24 with the external thread 26 is subsequently screwed into the internal thread 28 in order to fasten the anti-friction bearing 22. During the screwing in of the fastening ring 24, a tool engagement contour 36 is used which, in the embodiment which is shown, is formed by way of four substantially rectangular pockets which are arranged uniformly on the circumference of the fastening ring 24. Said tool engagement contour 36 can interact with a tool (not shown). In this way, the fastening ring 24 can be screwed easily into the housing 12.

It goes without saying that the tool together with the tool engagement contour 36 can also be used to screw the fastening ring 24 out of the housing 12.

1. A steering system shaft bearing assembly comprising:
a shaft which is mounted in a housing made from plastic via an anti-friction bearing such that it can be rotated about a shaft axis,
wherein the anti-friction bearing being fastened to the housing by means of a fastening ring which has an external thread and cooperates with a housing-side internal thread.

2. The steering system shaft bearing assembly as defined in claim 1, characterized in that an outer ring of the anti-friction bearing is mounted on a housing shoulder of the housing radially with regard to the shaft axis and/or bears against a housing-side stop face axially with regard to the shaft axis.

3. The steering system shaft bearing assembly as defined in claim 2, characterized in that the internal thread is arranged adjacently with respect to the housing shoulder along the shaft axis, the internal thread adjoining the housing shoulder, in particular.

4. The steering system shaft bearing assembly as defined in claim 2, characterized in that, on an axial side which is opposed with respect to the housing-side stop face, the outer ring bears against a stop face on the fastening ring side.

5. The steering system shaft bearing assembly as defined in claim 4, characterized in that the anti-friction bearing is mounted substantially without play on the housing.

6. The steering system shaft bearing assembly as defined in claim 5, characterized in that the shaft extends through the fastening ring.

7. The steering system shaft bearing assembly as defined in claim 6, characterized in that the fastening ring comprises at least one tool engagement contour which is configured to interact with a tool, by means of which the fastening ring can be screwed.

8. The steering system shaft bearing assembly as defined in claim 4, characterized in that the housing is a sensor housing or a gear housing of a steering system for a motor vehicle, in particular for an automobile.

9. The steering system shaft bearing assembly as defined in claim 4, characterized in that the housing is an injection molded housing, and the internal thread is produced during the injection molding.

10. (canceled)

11. (canceled)

12. (canceled)
